(19) United States
(12) Patent Application Publication
(10) Pub. No.: US 2022/0205271 A1
(43) Pub. Date: Jun. 30, 2022

(54) MODERN PORTABLE CAR UMBRELLA

(71) Applicant: Ali AHMED, Doha (QA)

(72) Inventor: Ali AHMED, Doha (QA)

(21) Appl. No.: 17/613,163

(22) PCT Filed: Jan. 1, 2020
(86) PCT No.: PCT/QA2020/050001

§ 371 Date: Nov. 22, 2021

(30) Foreign Application Priority Data
Jun. 18, 2019 (QA) QA/201906/00339

(51) Int. Cl. E04H 15/06; E04H 15/48; B60J 11/04

(52) U.S. Cl. CPC E04H 15/06; B60J 11/04; E04H 15/48

(57) ABSTRACT

Modern Portable Car Umbrella Fabrication of modern and simple Car Umbrella. It is light, easy to use, less cost and short time to fix and fold. It depends on the following ideas. 1—Horizontal extension of the Umbrella, by using two or three coaxial tubes with springs in between the tubes and tightening threads for folding. 2—Using parts of magnets to fix the Umbrella on the car. Magnets are covered with soft clothes to protect the car paint; it can be permanent or electrical magnets. 3—Fragmentation of the Umbrella into two parts; One part will be fixed on the front of the car, and the other one on the back side. 4—Merging two normal Umbrellas to make a car umbrella or family beach Umbrella.

### EXISTING TECHNOLOGY

Normal Car Umbrellas

### SHORTAGE IN THE EXISTING TECHNOLOGY

1) Opening and folding in normal Car Umbrellas are made by rotation of the opening parts 90-degree angle up/down for opening/folding. So, it requires many supports and hinges.
2) Currently to fix the Car Umbrella, we need to put it on the top of the Car and fix it with many ropes on the Car doors.
3) Current Umbrellas are one part with one main fixing base and one movement (rotation in 90 degree up/down) of the opening parts.
   All previous reasons can lead to the following disadvantages:
   Heavy weight of the Umbrella.
   Difficult to Carry and use.
   Expensive.
   Take long time to fix/remove.
   Limited sizes cannot be used for the big Cars.

The new features of the modern Car Umbrella:

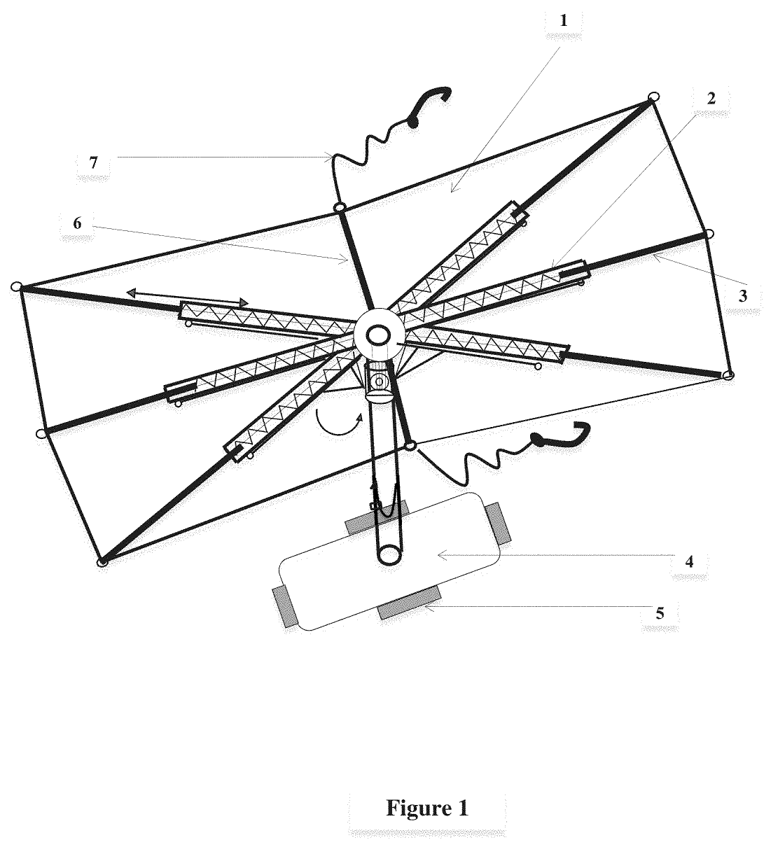

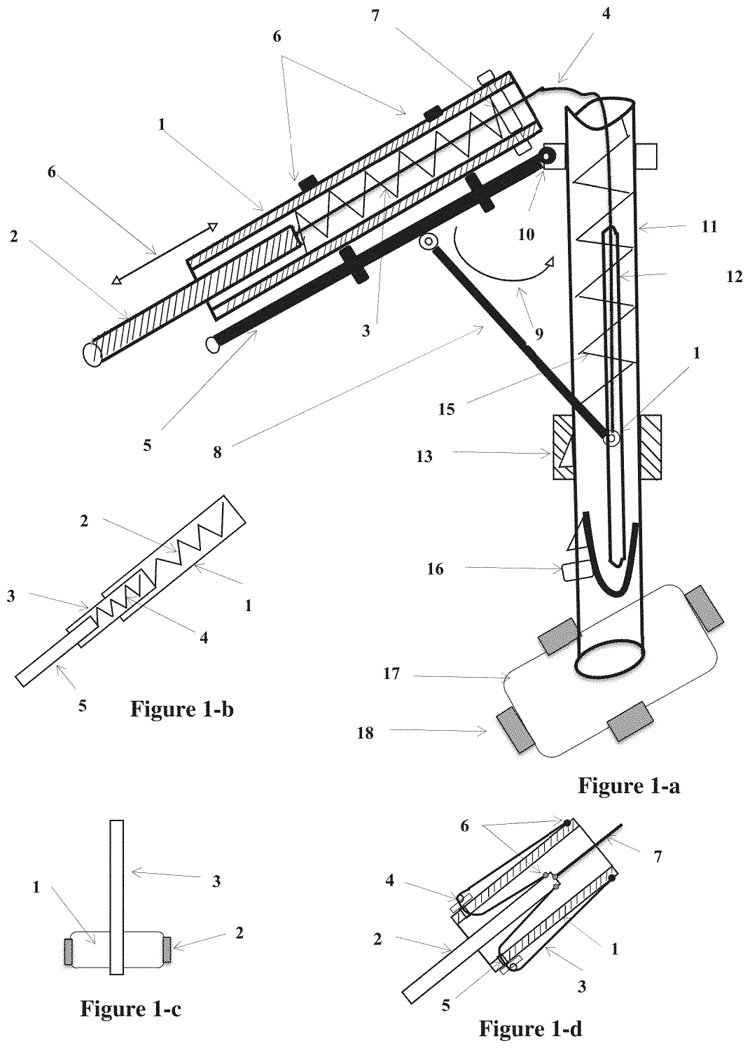

We can use the following ideas to make Car Umbrella with less cost, easier use, more efficient, and quick to fix/remove:
1) Horizontal opening of the Umbrella:
   In addition to the rotation 90 degree vertically around the axle of the Umbrella we added the horizontal opening by using coaxial tube with a metal springs in between the tubes for opening the Umbrella, and tightening threads for folding the Umbrella. This idea is illustrated in the FIGS. 1 and 1-a,
2) Using the Magnets to fix the Umbrella on the Car:
   We are utilizing the magnetization feature of the Car frames which fabricated from the iron to fix the Umbrella by using magnetic base. This idea is illustrated in the FIG. 1-a, and the other figures.

3) Fragmentation of the Umbrella into two parts with two fixing bases:
This type of the Umbrella is very simple, cheap, and easy to use, it consists of two identical parts to Carry the Umbrella; one part will be fixed on the front side of the Car and the other one will be fixed on the back-side. Each one is consisting of base (magnetic or mechanical base), vertical axle, and two wings for opening and folding the Umbrella, the two wings are jointed together in the wing bases with a metal spring or elastic robe to keep them in the opening position. The front side part and back-side part are jointed together with the Umbrella clothes, and spiral folding metal tape.
4) Merging of two normal Umbrellas with a complementary Umbrella clothes to make a Car Umbrella or Family Beach Umbrella.

Detailed drawing illustrating the components of each Car Umbrella and theory of work, and the following is detailed description for the drawings:

FIG. 1

Portable Car Umbrella with two movements of the opening parts and magnetic fixing base:

Normal movement (rotation in 90 degree up/down) and the new horizontal movement by using coaxial tubes, springs and tightening threads, and we are fixing this Umbrella by using magnetized base. This Umbrella is light weight, simple, easy to use, quick fixing, and it, can be fabricated in many sizes based on the Car size.

Components:
1. Umbrella clothes
2. 5 mm inner diameter Tube of acrylic, aluminum, or strong & light plastic
3. 3 mm diameter Fiber optic rod which fixed in the tube No 2.
4. Fixing base which can be wood, Teflon, or plastic.
5. Magnets fixed on the base and covered with soft clothes or thin layer of plastic to protect the Car paint (magnets can be a permanent or electrical type).
6. Umbrella links for the 90-degree movement.
7. Plastic hook for additional fixing during windy days.

FIG. 1-a

It is a description for the main parts of FIG. 1:

Components:
1. 5 mm inner diameter Tube of acrylic, aluminum, or strong & light plastic,
2. 3 mm diameter Fiber optic rod/tube which fixed inside the tube No 1, to make the required extension opening of the Umbrella.
3. Metal spring to press on the rod/tube for opening (Horizontal movement).
4. Strong tightening thread to pull the rod/tube to fold or shrink the Umbrella,
5. 5 mm diameter Fiber optic rod to make the 90-degree rotation movement and to be used for fixing the tube No. 1.
6. Wire or clips to engage and fix the tube No 1 with the rod No 5.
7. Plastic wheel to make the tightening thread to move smoothly.
8. Fiber optic link between the rod No. 5 and the cylindrical handle.
9. 90-degree movement.
10. fling.
11. Main fixing axle (light metal tube with 12 mm diameter).
12. 3 mm vertical hole for movement of the screw No 14.
13. Opening/closing handle which fixed around the main axle freely.
14. Screw fixed on the handle and used to hold the tightening thread and opening spring.
15. Metal or elastic rope spring to make the 90-degree movement.
16. Releasing button to open the Umbrella.
17. Fixing base which can be wood, Teflon, or plastic.
18. Magnets fixed on the base and covered with soft clothes or thin layer of plastic to protect the Car paint (magnets can be a permanent or electrical type).

FIG. 1-b

Multistage coaxial tubes to be used in case of requirement of wider Car Umbrellas to gives a chance to use a smaller spring with less weight, less strength, and less cost:

Components:
1. 7 mm inner diameter Tube of acrylic, aluminum, or strong & light plastic.
2. Metal spring to press on the tube No 3 for opening (Horizontal movement).
3. 5 mm inner diameter Tube of acrylic, aluminum, or strong & light plastic.
4. Metal spring to press on the tube No 5 for opening (Horizontal movement).
5. 3 mm rod of acrylic, or fiber optic.

FIG. 1-c

In this case we are fixing the main Axle in the same level of the fixing base and not perpendicular like the normal way, and we use this way to fix the Umbrella easily on the back-side of the big Cars.

Components:
1. Fixing base which can be wood, Teflon, or plastic.
2. Magnets fixed on the base and covered with soft clothes or thin layer of plastic to protect the Car paint (magnets can be a permanent or electrical type).
3. Main fixing axle (light metal tube with 12 mm diameter).

FIG. 1-d

Regarding to the horizontal opening mechanism; in case of unavailability of the metal springs which pushing the opening rod, we can use the elastic threads for opening the extension, the elastic threads will pull the opening rod outside of the tube instead of pushing force by the spring.

Components:
1. 5 mm inner diameter Tube of acrylic, aluminum, or strong & light plastic.
2. 3 mm diameter Fiber optic rod/tube which fixed inside the tube No 1, to make the required extension opening of the Umbrella.
3. Elastic thread fixed on the base of the tube No 1 and base of the rod/tube No 2 and moving on the wheel No. 4.
4. Wheel to make a smooth movement and reduce the friction of the elastic thread No 3.
5. Hole in the external tube to let the elastic robe move through
6. Fixing points of the elastic thread.
7. Normal thread used for folding the Umbrella.

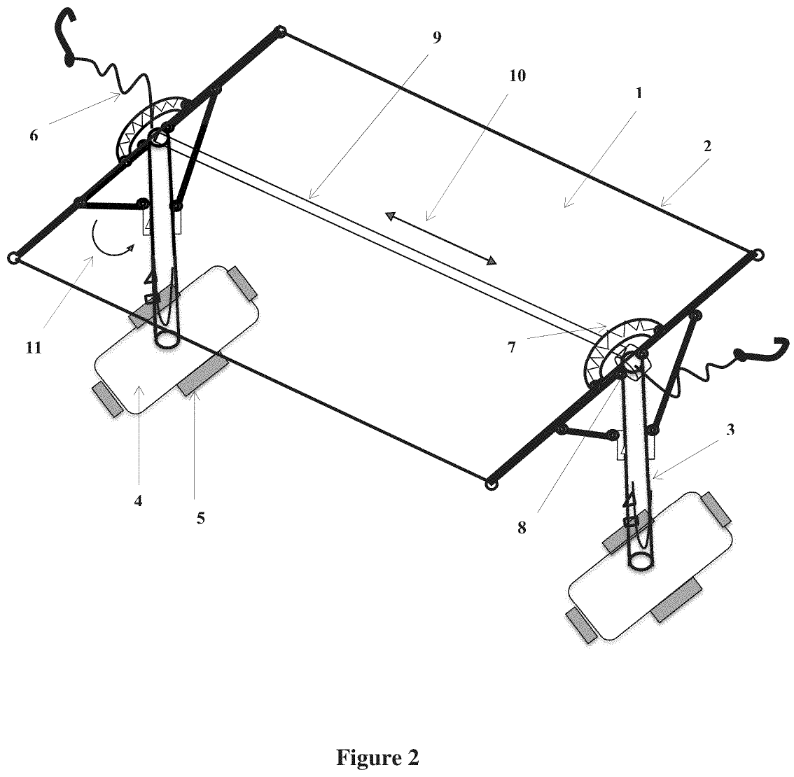

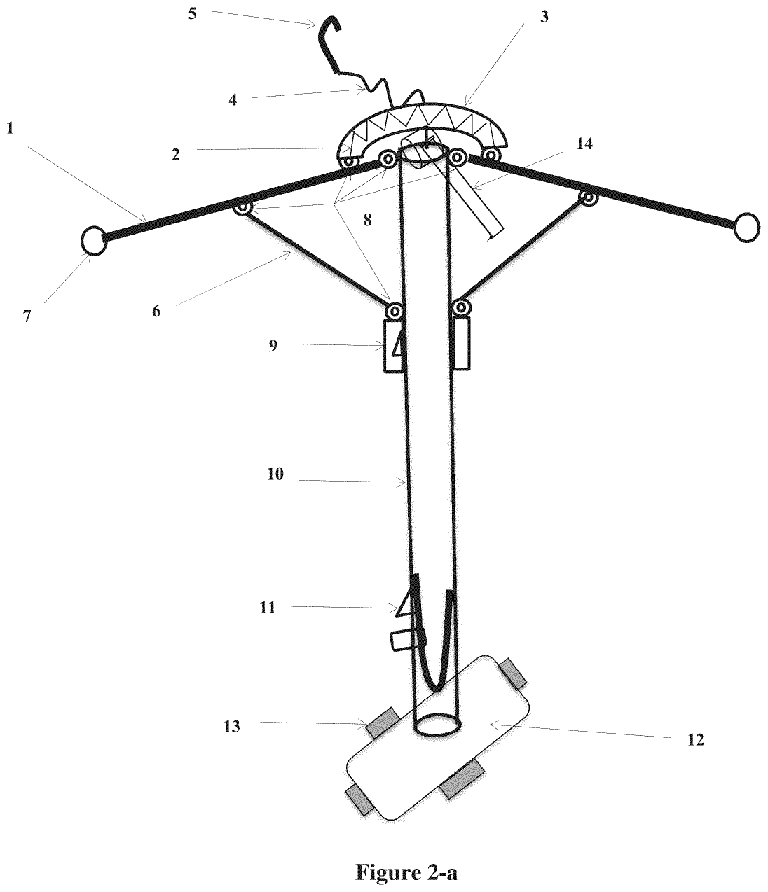

FIG. 2

Simple idea with less cost and easy use of the Car Umbrella by fragmentation of the Umbrella into two parts and two magnetic fixing bases; one base will be fixed on the front side of the Car and the other one will be fixed on the back-side.

Components:
1. Umbrella clothes.
2. Elastic Robe.
3. Main axle.
4. Fixing base (wood, Teflon, or plastic).
5. Magnets fixed on the base and covered with soft clothes or thin layer of plastic to protect the Car paint (magnets can be a permanent or electrical type).
6. Plastic Hook and Elastic robe for additional fixing during windy days.
7. Metal spring or elastic robe inside a flexible hose to be used as opening mechanism.
8. Folding spring metal tape (spiral tape same idea of the metal length meter tape).
9. Horizontal movement in case of folding the Umbrella.
10. Vertical 90-degree movement for opening and closing the two wings.

FIG. 2-a

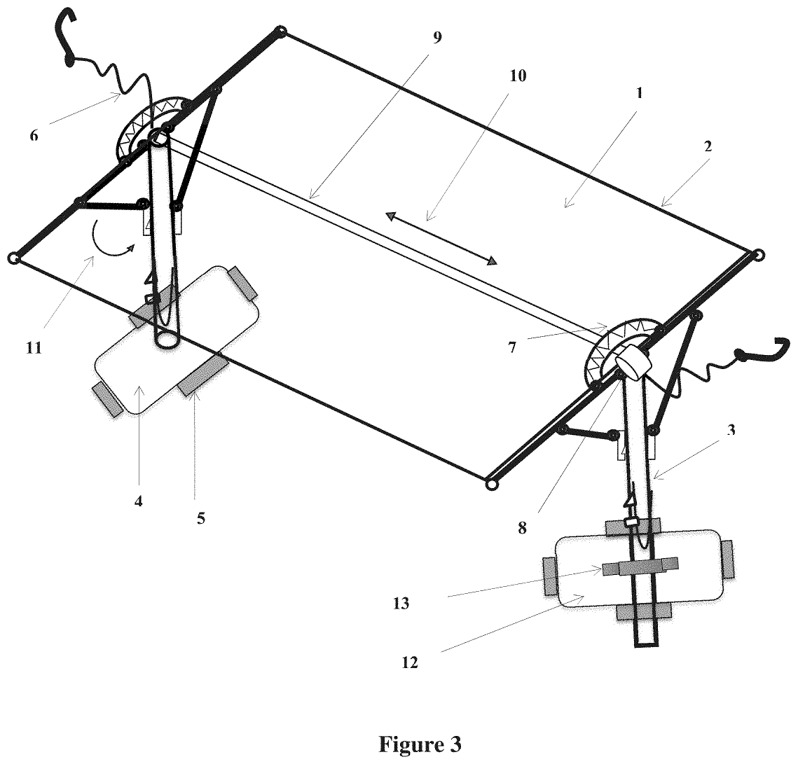

Detailed description of the opening/closing mechanism and fixing way for the FIGS. 2 and 3.

Components:
1. 5 mm Fiber optic or acrylic rod.
2. Metal spring or elastic robe inside a flexible hose to be used as opening mechanism.
3. Flexible hose to be a cover and guide for the spring.
4. Elastic rope.
5. Plastic hook.
6. Free fiber optic or metal link to joint between the main axle and opening rod No 1
7. End point of the rod No 1 for eye safety.
8. Fixing Hinges.
9. Folding handle.
10. Main axle.
11. Releasing system for opening the Umbrella.
12. Fixing base which can be wood, Teflon, or plastic.
13. Magnets fixed on the base and covered with soft clothes or thin layer of plastic to protect the Car paint (magnets can be a permanent or electrical type).
14. Folding system to fold the front base with the back-side base to be a one part when we need to fold and store the Umbrella; it is metal tape spring which having two movements one linear and one circular same like metallic length meter.

FIG. 3

It is same idea of FIG. 2 but with one deference for fixing mechanism to make it usable for the big Cars. It consists of two parts and two magnetic fixing bases; one base will be fixed on the front side of the Car and the other one will be fixed on the backside.

Components:
1. Umbrella clothes.
2. Elastic Robe.
3. Main axle.
4. Front Fixing base (wood, Teflon, or plastic).
5. Magnets fixed on the base and covered with soft clothes or thin layer of plastic to protect the Car paint (magnets can be a permanent or electrical type).
6. Plastic Hook and Elastic robe for additional fixing during windy days.
7. Metal spring or elastic robe inside a flexible hose to be used as opening mechanism.
8. Housing of the horizontal folding mechanism of the Umbrella.
9. The metallic spring tape for horizontal folding mechanism of the Umbrella.
10. Horizontal movement in case of folding the Umbrella.
11. Vertical 90-degree movement for opening and closing the two wings,
12. Back-side Fixing base (wood, Teflon, or plastic) in this case we are fixing the main axle in the same level of the base to be able to fix it easily on the back-side of the big Cars.
13. Metal clips to fix the main axle with the base in the same level.

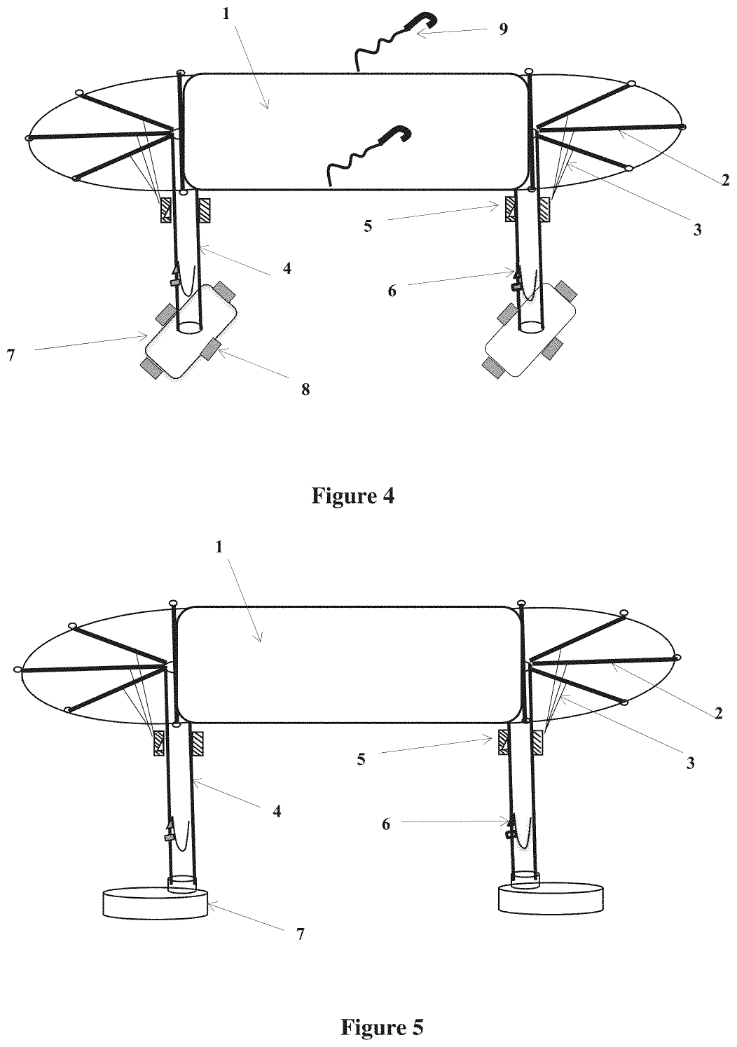

FIG. 4

Merging of two normal Umbrellas with two magnetic or mechanical fixing bases to make a Car Umbrella.

Components:
1. Umbrella clothes.
2. Fiber optic or metal rods which carry the Umbrella clothes.
3. Links between the handle and the rods No 2.
4. Main fixing axle.
5. Folding Handle.
6. Releasing button to open the Umbrella.
7. Fixing base which can be wood, Teflon, or plastic.
8. Magnets fixed on the base and covered with soft clothes or thin layer of plastic to protect the Car paint (magnets can be a permanent or electrical type).
9. Plastic hook for additional fixing during windy days.

FIG. 5

Appling the previous idea (Car Umbrella No 4) by using same Car Umbrella to be a Family Beach Umbrella and this can be done only by replacing the fixing bases to be a plastic container which can be filled with some beach sands to fix the Umbrella on the Beach ground.

Components:
1. Umbrella clothes.
2. Fiber optic or metal rods which carry the Umbrella clothes.
3. Links between the handle and the rods No 2.
4. Main fixing axle.
5. Folding Handle.
6. Releasing button to open the Umbrella.
7. Fixing base which consists of open plastic container which can be filled with some beach sands for fixing the Umbrella on the beach ground.

1-4. (canceled)

5. A method of horizontally movement (expansion and shrinking) of the umbrella without requirements of known heavy supports, to carry umbrella clothes, the method comprising:
fabricating of light car Umbrella about 2 Kilograms or less by using horizontal movement of the umbrella, to be easier, quicker for use, and cheaper for the customers;
obtaining horizontal movement by using light metal springs for expansion of the umbrella, and keeping this position until folding;
tightening threads jointed between the rods and handle to fold the umbrella when needed; and
using light acrylic or plastic or aluminum tube to be a guide for the rods or/and support rods, and to be a container for the springs ended with roller wheel in the end of the tubes to keep smooth movement of the tightening threads and protecting them from damage.

6. A system for Horizontal movement of the umbrella, by using Rubber tightening threads for expansion, and normal tightening threads for folding, characterized in that:
an expansion mechanism consists of rubber threads which jointed to the back end of the rod and other side jointed to the back end of the tube, pathing through hole in the front end of the tube, and fixed on the rotating wheel which fixed below the holes and outside the tube to protect the rubber threads;
a tube with hole in the front end to guide and hold the rubber threads and guide the fiberglass rod and external wheel under the hole on the front end of tube to smooth the movement of rubber thread;
a fiber-glass rod, used as a movable part, this rod tightened with the folding threads in the bottom end and with the outer end of umbrella clothes to carry umbrella clothes and do the required horizontal movement;
and
tightening threads for folding the umbrella jointed between the rods and the opening handle.

7. A method of fixing and removing the umbrella as claimed in claim 5, quickly by using electrical magnets covered with soft clothes or any soft material to protect the car paint, Magnets will be driven by battery, external electronic board, and manual switch for activation and de-activation; all will be fixed on the fixation base refer FIGS. 1 to 5 in the original drawing as filed.

8. A system for splitting the Car umbrella into two parts to hold umbrella clothes; comprises:
one part which will be fixed on the car hood and the other one will be on the trunk, wherein each part consists of base, fixing rod, and two opening wings jointed together with a spring for opening, in addition to tightening threads for folding:
characterized in that,
the clothes jointed between the two front and back parts;
the wings are two fiberglass rods 5 mm diameter 120 cm length jointed with umbrella clothes and jointed to a fixation rod;
the fixation rod can be Aluminum, plastic, stainless, wood or any material, the fixation and support rod jointed to the wings and to the fixation base;
an opening Spring is the one which fixed in between the two wings in the upper side, creating a force to keep the shed in the opening position until we fold it;
a spiral folding spring between front part and rear part of the umbrella to help the user for quick folding.

9. A method of merging two normal Umbrellas as claimed in claim 8, with 2 fixation points to fabricate a longer (wider) Umbrella which can be used for Car or Beach.
